(19) United States
(12) Patent Application Publication
(10) Pub. No.: US 2026/0042229 A1
(43) Pub. Date: Feb. 12, 2026

(54) DEVICE AND METHOD FOR REMOVING A CLOSING ELEMENT

(71) Applicant: OPTIMA pharma GmbH, Schwäbisch Hall (DE)

(72) Inventors: Christian Naser, Niederstetten (DE); Matthias Hofmann, Ilshofen (DE); Felix Seeliger, Schwäbisch Hall (DE); Florian Weippert, Schwäbisch Hall (DE)

(73) Assignee: OPTIMA pharma GmbH, Schwäbisch Hall (DE)

(21) Appl. No.: 19/363,078

(22) Filed: Oct. 20, 2025

Related U.S. Application Data
(63) Continuation of application No. PCT/EP2024/059968, filed on Apr. 12, 2024.

(30) Foreign Application Priority Data
Apr. 20, 2023 (DE) 102023110123.4

(51) Int. Cl. B25J 15/00

(52) U.S. Cl. CPC B25J 15/0071

(57) ABSTRACT

The invention relates to a device for removing a closing element from a transport section, in particular a supply section, of a filling and/or closing machine, in particular for the pharmaceutical industry, using a manipulator (3), the device comprising an end effector (2), which can be connected to the manipulator (3) releasably without tools or not releasably without tools for a handling for removing the closing element (4), and a needle (20), wherein the end effector (2) has a holder (22) on which the needle (20) is attached and/or which is produced integrally with the needle (20), and/or wherein the end effector has gripper elements so that the needle (20) can be gripped by the end effector, and wherein the closing element (4) can be speared by the needle (20) and the speared closing element (4) can be removed from the transport section. The invention further relates to a method for removal of a closing element from the transport section using a needle (20), and a use of a needle (20) for removal of a closing element from a transport section of a filling and/or closing machine.

### CROSS-REFERENCE TO RELATED APPLICATIONS

This application is continuation of PCT/EP2024/059968, filed Apr. 12, 2024, and claims priority to German Patent Application No. 102023110123.4, filed Apr. 20, 2023, the entire contents of both of which are hereby incorporated by reference.

### TECHNICAL FIELD AND PRIOR ART

The invention relates to a device and a method for removing a closing element from a transport section, in particular a supply section, of a filling and/or closing machine, in particular for the pharmaceutical industry. The invention furthermore relates to the use of an element for removing a closing element from a transport section of a filling and/or closing machine, in particular for the pharmaceutical industry.

Filling and/or closing machines for the pharmaceutical industry are used for filling liquid or powdery pharmaceutical and biopharmaceutical products into containers, such as small bottles (vials), infusion bottles, carpoules, single-use syringes or similar, wherein the containers are closed by a closing element, such as e.g. a closing plug and/or a cap, preferably as soon as possible after filling and any subsequent inspection.

Filling of sensitive or hazardous products is usually carried out in an closed environment, such as an isolator. In addition, filling and/or closing machines without isolator are also known for filling pharmaceuticals and/or other products, using for example so called restricted barrier systems (RABS).

For supplying closing elements, supply sections with rails are known, wherein the closing elements are conveyed along the rails by means of gravity and/or by applied vibrations. In some designs, the closing elements are transported with a fixed orientation. Incorrectly oriented closing elements and defective closing elements, e.g. oversized closing elements, may cause a fault, in particular an accumulation in the supply section and/or in subsequent processing.

Faults in the process sequence of filling and closing may lead to a stoppage of the system. In particular when processing small batches in a filling and/or closing machine however, there is great interest in avoiding stoppages as far as possible. Also, an unplanned stoppage of a filling and/or closing machine may mean that the products are no longer usable. This applies in particular—but not exclusively—to sensitive biopharmaceutical products.

### OBJECT AND SOLUTION

It is therefore the object of the invention to provide a device and a method for removing a closing element from a transport section of a filling and/or closing machine, in particular for the pharmaceutical industry, which allow a rapid and safe removal of a closing element from a transport section.

This object is achieved by the device, the system and method with the features of claims 1, 5 and 6, and the use with the features of claim 8. Advantageous embodiments arise from the dependent claims.

According to a first aspect, a device is provided for removing a closing element from a transport section, in particular a supply section, of a filling and/or closing machine, in particular for the pharmaceutical industry, using a manipulator, wherein the device comprises an end effector which can be connected to the manipulator releasably without tools or not releasably without tools for a handling for removing the closing element, and a needle, wherein the end effector has a holder to which the needle is attached and/or which is produced integrally with the needle, and/or wherein the end effector has gripper elements so that the needle can be gripped by the end effector, wherein the closing element can be speared by the needle and the speared closing element can be removed from the transport section.

The invention uses the findings that a closing element to be removed must be definitively removed from the process cycle, and therefore damage to the closing element on removal from the transport section by spearing the closing element may be tolerated. By spearing the closing element to be removed, contact of the end effector and/or needle with an environment of the closing element and/or with elements situated in the environment, e.g. adjacent closing elements, can be reliably avoided.

A needle for spearing the closing elements may be designed suitably for the intended use. In some embodiments the needle is straight and tapers to a tip in the direction of a distal end. Such a needle is particularly suitable for spearing a cap or a closing plug which is used for closing a container filled with a pharmaceutical product, such as for example but not exclusively for closing a syringe, a carpoule or a vial. In some embodiments, the closing element is an aluminium cap and/or a crimp cap. In other embodiments, the closing element is made of polyethylene, e.g. as a snap cap. In yet other embodiments, the closing element is a plug of an elastic polymer, for example of butyl rubber (IIR) or bromine butyl rubber (BIIR). In yet other embodiments, the closing element is a combination packing means. The described closing elements can easily be speared with a needle with a tapered tip, and transported away while speared. The invention is not however restricted to the use of the device for such closing elements. Also, depending on application, other designs of needle are conceivable, for example with barbs which allow spearing of a specific closing element for subsequent movement.

In the context of the application, a manipulator is defined as any kinematic via which the end effector can be moved fully or partly automated for removal of the closing element. The manipulator is in particular configured such that a movement of the end effector for removing the closing element in an isolator is possible. Thus there is no need for a user to reach into an isolator, e.g. via a gloved access, for removing the closing element. In one embodiment, removal is fully automated, wherein a manipulator can be moved for removal of the closing element without interaction of the user. In other embodiments, removal is partly automated, wherein a manipulator is moved at least in portions based on control commands of a user. The control commands may be predefined depending on a specific use by means of a suitable man-machine interface.

Depending on embodiment, the manipulator may be tooled-up, i.e. the device may mounted on the manipulator, during or before first fitting of the isolator and before decontamination and commissioning of the isolator. In other embodiments, the manipulator may be tooled-up after decontamination of the isolator, wherein the end effector is introduced into the isolator via a lock. In some embodiments, a tooling-up after decontamination of the isolator takes place manually via a gloved access, and in other embodiments a tooling-up is fully or partly automated.

On tooling-up of the manipulator, in some embodiments the end effector is mounted on the manipulator by means of a connection which is not releasable without tools. In connection with the application, a connection not releasable without tools means a connection which, depending on embodiment, cannot be released non-destructively or can only be released non-destructively using a tool.

The end effector connected to the manipulator so as to be not releasable without tools is for example an actively controllable gripper arranged on the manipulator, by means of which the needle can be gripped. In some embodiments, the needle can be gripped by an end effector configured e.g. as a parallel gripper. In one embodiment, movement between the needle and the parallel gripper is prevented because of friction between the needle and the parallel gripper. In one embodiment, the needle has a coating and/or a surface structure in a holding section, via which a friction force is increased. In another embodiment, the needle has a protrusion acting as a stop and/or a cross-section change, wherein by means of the protrusion and/or cross-section change, a movement between the needle and parallel gripper when spearing the closing element is prevented.

In another embodiment, the needle is part of the end effector and fixedly, i.e. not releasably without tools, attached to the holder of the end effector, or is an integral part of the holder. In some embodiments, the end effector with needle arranged thereon can be connected to a manipulator releasably without tools, so that when the end effector is not in use, the manipulator can be used for other tasks by changing the end effector. In some embodiments, the manipulator comprises a gripper tool which is not releasable without tools, by means of which the end effector with the needle can be gripped. In other embodiments, the manipulator and the end effector have coupling elements for coupling of the end effector to the manipulator without tools. The coupling elements are preferably passive coupling elements and configured such that the end effector can be sterilised, in particular in an autoclave, without hindering the function of the coupling element. The end effector can be introduced into the isolator for example via a lock and connected to the manipulator. In yet other embodiments, the end effector with holder and needle arranged thereon is connected to the manipulator so as to be not releasable without tools.

In some embodiments, the holder is dimensioned such that no joints or similar elements of the manipulator need be arranged above the transport section, in particular the supply section, for removal of the closing element from any arbitrary position in the transport section. The holder itself is preferably configured such that cleaning and sterilisation, in particular in an autoclave, are possible. Arrangement of the holder above the supply section of the closing element and/or in a primary air supply is therefore acceptable. Alternatively or additionally, the holder is configured such that when the needle is positioned in the transport section, in particular the supply section, a primary air supply to the transport section, in particular the supply section, is not affected or only to a tolerable extent.

To this end, in one embodiment the holder is configured as a cantilever arm comprising a first end which can be connected to the manipulator releasably without tools or not releasably without tools, and a second free end, wherein the needle is arranged on the second end. A length of the holder between the first end and the second end can be selected suitably by the person skilled in the art depending on application, so that in use a safe movement of the needle for spearing the closing element is possible, and an arrangement of joints or similar elements of the manipulator above the transport section, in particular the supply section, can be avoided. The dimension of the cantilever arm perpendicular to its length can be suitably selected according to the specific use in order to achieve minimal covering of the transport section during use and adequate stability.

In some embodiments, the end effector is configured such that the end effector can be sterilised, in particular autoclaved.

In one embodiment, the needle is attached to the holder of the end effector so as to be adjustable between the usage position in which a needle tip is exposed and a stowage position in which the needle tip is covered. In other embodiments, the needle is attached stationarily to the holder or is an integral part of the holder, so that no movable parts on the end effector are required. Such a design is advantageous in particular when the end effector is used in an isolator, since the end effector can be cleaned and/or sterilised well, and in particular sterilised without residue in an autoclave.

In one embodiment, the device has a deposit station with a cap holder for a protective cap, wherein the end effector with needle attached thereto or the needle can be deposited in the deposit station when not in use such that on deposit, the needle can be inserted into a protective cap present in the cap holder. By means of the protective cap, both a needle tip can be protected from damage and damage to a glove on contact with the needle during gloved access, and/or damage to another component on contact with the needle, can be avoided.

In one embodiment, the protective cap is attached to the cap holder so as to be not releasable non-destructively or only by means of a tool. In other embodiments, the protective cap is held on the cap holder so as to be releasable without tools, wherein the end effector with needle and/or the needle can be removed from the deposit station either with or without protective cap. In particular, in some embodiments it is provided that the end effector with needle and/or the needle can be removed from the deposit station either with or without protective cap depending on a movement path of the end effector during removal from the deposit station.

In other embodiments, there is no protective cap, wherein when not in use, the end effector is positioned such that contact with a glove of a gloved access and/or contact with other moving parts is excluded or at least almost excluded.

In one embodiment, the device furthermore has an ejection station with a scraper element, wherein the speared closing element can be scraped off the needle by a relative movement between the end effector and the scraper element. In some embodiments, the scraper element is held stationary, wherein the needle can be moved by the manipulator relative to the scraper element for scraping the closing element off the needle.

According to a second aspect, a system is provided comprising a manipulator and an above-described device having an end effector with a needle, wherein the end effector can be moved by means of the manipulator fully or partly automated for removal of the closing element by spearing the closing element with the needle.

According to third aspect, a method is provided for removing a closing element from a transport section of a filling and/or closing machine, in particular for the pharmaceutical industry, using a manipulator and an end effector, wherein the end effector can be connected to the manipulator releasably without tools or not releasably without tools for a handling for removing the closing element, wherein the closing element is speared by a needle provided on the end effector and/or gripped by the end effector, and the speared closing element is removed from the transport section.

Depending on embodiment, the manipulator is tooled-up, i.e. the end effector connected to the manipulator, once on construction of an associated device or multiple times, e.g. as required after detection of a closing element to be removed.

For spearing the closing element using the manipulator, the movement of the end effector can be fully or partly automated. In one embodiment, the movement of the manipulator is controlled by a user by means of an input device or another man-machine interface. In other embodiments, the manipulator is configured to carry out a movement for removing the closing element automatically without control inputs by a user.

In one embodiment, the end effector with needle and/or the needle is deposited in a deposit station when not in use. In other embodiments, the manipulator with connected end effector is brought into a stowage position when not in use, wherein the stowage position is selected such that contact of the needle with moving parts and/or with gloves of a gloved access of an isolator is avoided.

In some embodiments, the speared closing element is scraped off the needle by means of a relative movement between the end effector and a scraper element.

According to a fourth aspect, a use of a needle is provided for removing a closing element from a transport section, in particular a supply section, of a filling and/or closing machine, in particular for the pharmaceutical industry, wherein the closing element is speared by the needle for removal from the transport section.

As described above, the use of a needle allows spearing a closing element without contact between the needle, a person guiding the needle and/or a manipulator guiding the needle, and the environment or other closing elements arranged in the environment.

In some embodiments, the needle is part of an end effector or is connected thereto so as not to be releasable without tools, or can be gripped by means of an end effector, wherein the end effector can be connected to a manipulator releasably without tools or not releasably without tools for handling.

Use takes place in particular in an isolator, wherein the needle and the end effector are sterilised before introduction into the isolator, in particular in an autoclave.

### BRIEF DESCRIPTION OF THE DRAWINGS

Further advantages and aspects of the invention arise from the claims and the description of exemplary embodiments of the invention which are explained below with reference to the figures. In the drawings:

FIG. 1 shows an exemplary embodiment of a device for removing a closing element from a transport section, comprising an end effector with a holder and a needle attached to the holder;

FIG. 2 shows the end effector from FIG. 1 after positioning above a supply section for removing a closing element from the supply section;

FIG. 3 shows the end effector from FIG. 1 after spearing the closing element to be removed;

FIG. 4 shows the end effector from FIG. 1 on removal of the speared closing element from the supply section;

FIG. 5 shows an exemplary embodiment of a device for removing a closing element from a supply section, comprising the end effector from FIG. 1 and an ejection station;

FIG. 6 shows the ejection station from FIG. 5 while a closing element speared by means of the end effector is scraped off; and

FIG. 7 shows the ejection station from FIG. 5 after the closing element has been scraped off.

### DETAILED DESCRIPTION OF EXEMPLARY EMBODIMENTS

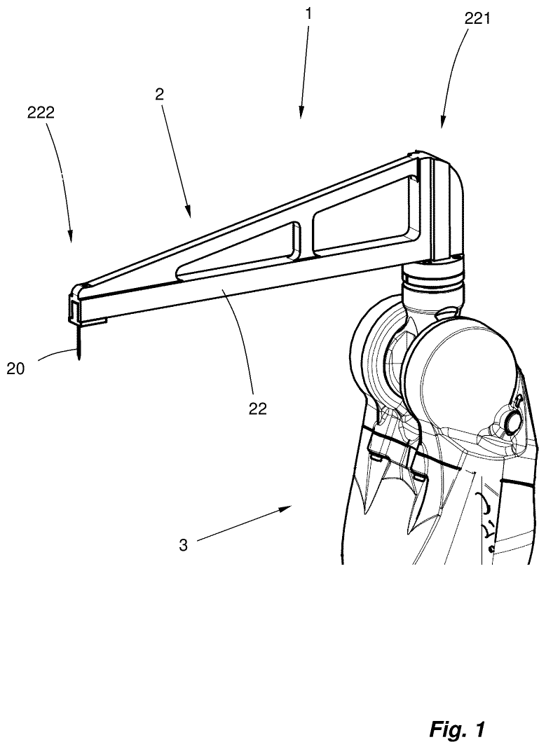

FIG. 1 shows an exemplary embodiment of a device 1 for removing a closing element (not shown in FIG. 1) from a transport section, in particular a supply section for the closing elements.

The device 1 comprises an end effector 2 with a holder 22 and a needle 20 attached to the holder 22. The end effector 2 can be connected to a manipulator 3 releasably without tools for a handling for removing the closing element 4. The manipulator 3 shown is an articulated arm manipulator. The invention is however not restricted to the use of the device 1 with an articulated arm manipulator.

The holder 22 shown is configured as a cantilever arm and has a first end 221 attached to the manipulator 3, and a second free end 222 on which the needle 20 is attached. The holder 22 shown in side view has a triangular contour with a right angle at the first end 221. A height of a side lying at the first end 221 and a length between the first end 221 and the second end 222 can be selected appropriately for the application. The length in particular can be selected such that using the end effector 2, all closing elements 4 of a defined portion of a transport section can be reached, without the manipulator 3 being arranged in a primary air supply to this portion. The triangular form allows stable guidance of the needle 20 in its longitudinal direction. The invention is however not restricted to the design of the holder 22 illustrated.

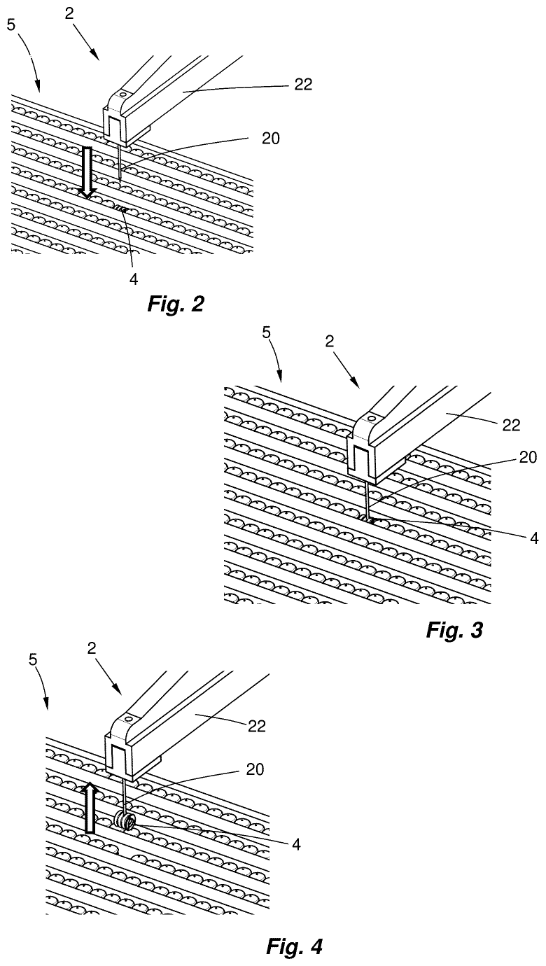

FIGS. 2 to 4 show schematically the end effector 2 of the device in FIG. 1 on removal of the closing element 4 from a supply section 5. The supply section 5 illustrated has multiple parallel tracks along which the closing elements 4 are supplied. The illustration is however purely exemplary.

FIG. 2 shows the end effector 2 after positioning above the supply section 5 for removal of the closing element 4, marked with a circle, from the supply section 5. As FIG. 2 shows, the end effector 2 is positioned such that the needle 20 is above the closing element 4 to be removed. In the exemplary embodiment illustrated, the end effector 2 is then moved—as indicated schematically by an arrow in FIG. 2—in the direction of the longitudinal axis of the needle 20, so that the closing element 4 is speared by the needle 20.

FIG. 3 shows the end effector 2 after spearing the closing element 4 to be removed.

As shown schematically in FIG. 4, the end effector 2 can then be moved with the speared closing element 4 in order to remove the speared closing element 4 from the supply section. As shown schematically by an arrow in the exemplary embodiment illustrated, for removal of the speared closing element 4, the end effector 2 is again moved in the direction of the longitudinal axis of the needle 20, in the vertical direction in the exemplary embodiment shown. The invention is not however restricted to this movement and, depending on design of transport section and/or closing element 4, other movements are suitable for keeping to a minimum any contact of the speared closing element 4 with further closing elements during removal of the speared closing element 4, and/or for reliably avoiding a loss of the speared closing element 4 during removal.

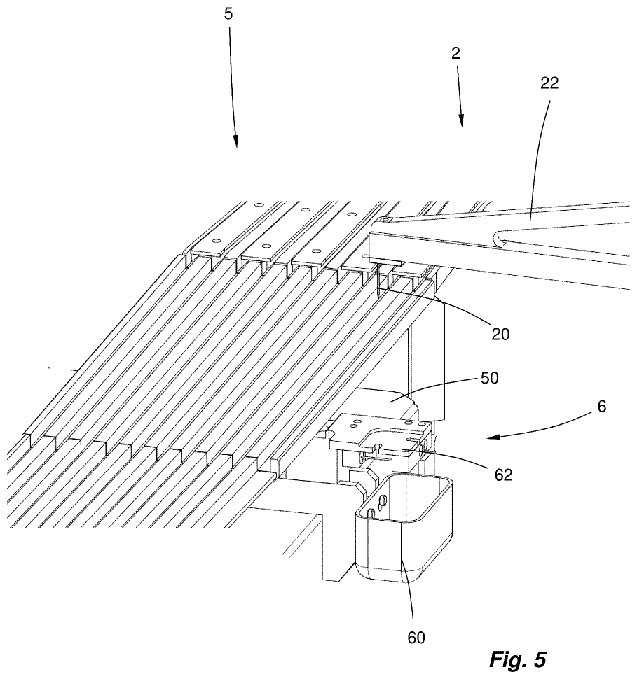

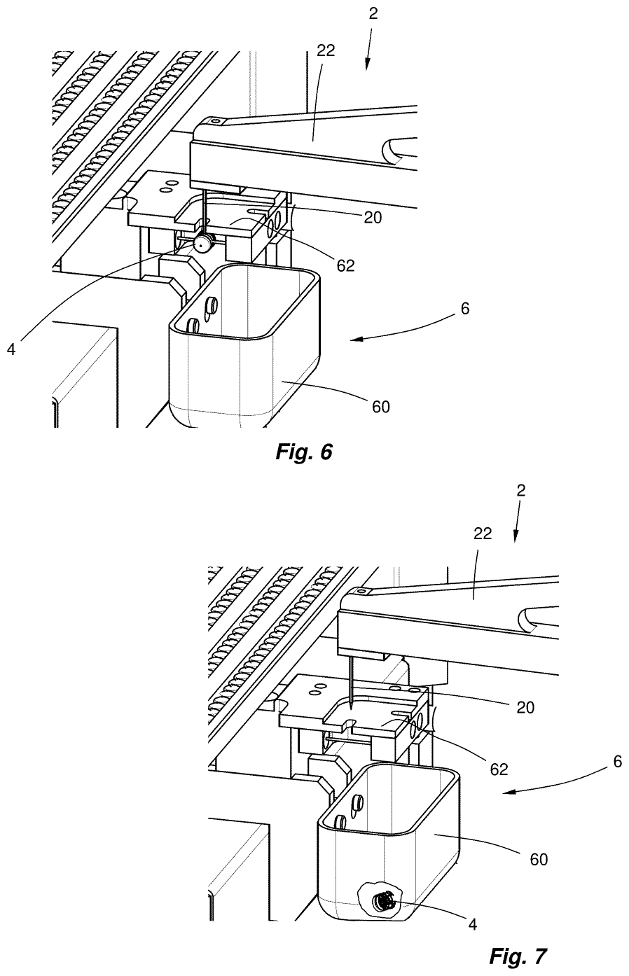

FIG. 5 shows an exemplary embodiment of a device 1 for removing a closing element 4 from a supply section 5, comprising the end effector 2 from FIG. 1 and an ejection station 6. FIGS. 6 and 7 show the ejection station 6 from FIG. 5 while a closing element 4, speared by the end effector 2, is scraped off and after the closing element 4 has been scraped off.

The ejection station 6 shown comprises a catchment container 60 and a scraper element 62. The catchment container 60 and the scraper element 62 are stationarily mounted on a frame 50 of the supply section 5. The scraper element 62 has an opening into which the needle 20 can be inserted so that the holder 22 and speared closing element 4 are arranged on opposite sides of the scraper element 62. In the exemplary embodiment shown, the closing element 4 is arranged on an underside of the scraper element 62, so that on upward movement of the end effector 2, the speared closing element 4 is retained by the scraper element 62 and detached from the needle 20. The catchment container 60, which is shown cut away in FIG. 7, is arranged below the scraper element 62 so that the detached closing element 4 falls into the catchment container 62.

In advantageous embodiments, the end effector 2 is moved by means of a manipulator 3 (see FIG. 1), wherein depending on embodiment, the manipulator 3 is moved fully or partly automated.

In some embodiments, the device 1 is arranged in an isolator. When not in use, the manipulator 3 is arranged in a position in which contact of the needle 20 with gloves of a gloved access is avoided.

1. A device for removing a closing element from a transport section, of a filling and/or closing machine, using a manipulator, the device comprising:
an end effector which can be connected to the manipulator releasably without tools or not releasably without tools for a handling for removing the closing element;
wherein the device has a needle;
wherein the end effector has a holder to which the needle is attached and/or which is produced integrally with the needle; and/or
wherein the end effector has gripper elements so that the needle can be gripped by the end effector;
wherein the closing element can be speared with the needle and the speared closing element can be removed from the transport section.

2. The device according to claim 1, wherein the holder is configured as a cantilever arm comprising a first end which can be connected to the manipulator releasably without tools or not releasably without tools, and a second free end, wherein the needle is arranged on the second end.

3. The device according to claim 1, wherein the end effector is configured such that the end effector can be sterilised.

4. The device according to claim 1, wherein an ejection station with a scraper element is provided, wherein the speared closing element can be scraped off the needle by a relative movement between the end effector and the scraper element.

5. A system for removing a closing element from a transport section, of a filling and/or closing machine, comprising:
a manipulator and a device according to claim 1 with an end effector;
wherein the end effector can be moved by means of the manipulator fully or partly automated for removal of the closing element.

6. A method for removing a closing element from a transport section, of a filling and/or closing machine, using a manipulator and an end effector,
wherein the end effector can be connected to the manipulator releasably without tools or not releasably without tools for a handling for removing the closing element,
wherein the closing element is speared by a needle provided on the end effector and/or gripped by the end effector, and the speared closing element is removed from the transport section.

7. The method according to claim 6, wherein the speared closing element is scraped off the needle by a relative movement between the end effector and a scraper element.

8. Use of a needle for removing a closing element from a transport section, of a filling and/or closing machine,
wherein the closing element is speared by the needle for removal from the transport section.

9. The use according to claim 8, wherein the needle is part of an end effector or is connected thereto so as not to be releasable without tools, or can be gripped by means of an end effector, wherein the end effector can be connected to a manipulator releasably without tools or not releasably without tools for handling.

10. The device according to claim 3, wherein the end effector is configured such that the end effector can be sterilised in an autoclave.
